(19) United States
(12) Patent Application Publication
(10) Pub. No.: US 2022/0274699 A1
(43) Pub. Date: Sep. 1, 2022

(54) A RAPIDLY DEPLOYED TERRESTIAL VISUAL DETECTION AND TRACKING SYSTEM

(71) Applicant: JJ1 Holdings Pty Ltd, Queensland (AU)

(72) Inventor: Jeannette Mary Jones, South Brisbane (AU)

(21) Appl. No.: 17/629,207

(22) PCT Filed: Jul. 16, 2020
(86) PCT No.: PCT/AU2020/000069

§ 371 Date: Jan. 21, 2022

(30) Foreign Application Priority Data
Jul. 22, 2019 (AU) 2019 902586

(51) Int. Cl. B64C 39/02; B64D 1/02; G01S 13/87; H04W 64/00

(52) U.S. Cl. CPC B64C 39/024; B64D 1/02; G01S 13/878; H04W 64/00; B64C 2201/122; B64C 2201/146

(57) ABSTRACT

A rapidly deployed drone-delivered terrestrial visual detection and tracking system for coordinating ground troops, equipment and military vehicles. In the preferred example, movements over terrain and changes to geographical locations are tracked and visually monitored in real time through heads up display visors of smart helmets worn by soldiers.

### FIELD OF THE INVENTION

This invention relates to combat or military operations. In particular it relates to a drone deployed terrestrial visual detection and tracking system for coordinating ground troops, equipment and military vehicles. It also concerns a system where movements over terrain and changes to geographical location can be tracked and visually monitored in real time via heads up display visors of smart helmets worn by the troops.

### BACKGROUND OF THE INVENTION

The coordination and tracking of soldiers, armored vehicles, medical personnel, and plant and equipment during a military operation is a complex task. Difficulties, of which, are compounded where geographical factors such as dense vegetation or rugged terrain make visual contact between combatants infrequent or even impossible. There have been numerous cases where confusion and misidentification has resulted in troops firing on their fellow combatants with obvious dire consequences. This is often euphemistically termed, “friendly fire” which in modern warfare can be horrifically catastrophic.

Poor visibility has also contributed to battlefield fatalities where injured soldiers cannot be located and appropriate medical attention provided in time. The accurate location of injured personnel is critical where an airborne evacuation has to be coordinated and organized. While prior art telecommunication systems go some way towards promoting efficient communication on the battlefield, they still rely on verbally communicated coordinates of individual troop or platoon positions for accurate location. Any visual display of troop positions such as on map representations are necessarily constructed from relayed radio messages and by definition not contemporaneous with the actual troop locations on the ground.

This is especially critical with a moving combat zone or advancing battle front. In a situation where troops are injured or radio communication is compromised, or if the radio is damaged, emergency signals are unable to be sent to headquarters or the central command base.

Furthermore, search and rescue operations undertaken at night or where visibility is compromised such as from smoke cannot be safely conducted unless there is a means of accurate location.

The best prior art telecommunication location systems rely on a network of intercommunicating transceivers which are uniformly distributed over the area of interest. Signals emitted from these nodes or beacons enable soldiers to be accurately located by well understood methods of triangulation. The problem in combat zones is that the laying down of the nodes or beacons before a battle poses an obvious problem. It is also not really feasible in an advancing or moving battle front situation where troop movements can be random and quick. Notwithstanding that the strategic planning of overall troop and armored vehicle movement is an extremely complex science, it is made even more difficult in the absence of any visual or real time information. There is therefore a need for a fast responding, accurate and real time visually facilitated, ground-based troop and military vehicle tracking system.

It is therefore an object of the present invention to seek to eliminate or ameliorate the problem(s) hereinbefore described by providing a rapidly deployable ground based real time visual detection and tracking system as herein and more fully described below.

### SUMMARY OF THE INVENTION

In a broad aspect, the invention resides in a rapidly deployable drone seeded terrestrial real time visual detection and tracking system comprising:

one or more remotely controlled flying drones;
a plurality of airborne transceivers adapted to be released in the air by the one or more drones; the transceivers dispersed over an area on the ground;
personnel transceivers carried or worn by persons on the ground;
equipment or vehicular transceivers attached or installed on ground based equipment or vehicles;
a central command computer adapted to receive and process wireless location information from the drone dispersed, equipment and vehicular transceivers;
the computer processing the location information to provide a seamless real time visual display of the locations of the personnel, vehicles and equipment relative to each other, and wherein,
changes to their location can be visually tracked and monitored in real time.

Preferably, the air borne transceivers are of a shape or configuration to enable them to travel through the air quietly and as noiselessly as is possible.

The air borne transceivers can have aerodynamic aids such as fins or vanes to minimize sideways displacement as they fall to the ground on being released.

They can have a ground piercing tip or specially adapted base to hold them in a substantially upright position on landing on the ground.

Suitably, the central computer is in wireless communication with each of the transceivers via one or more wireless protocols.

In a preferred example, the one or more wireless protocols include a Bluetooth wireless communication protocol.

In the alternative, or in addition, the one or more wireless protocols can include a wireless personal area network.

The one or more wireless protocols may comprise:

a mesh network of radio frequency identification (RFID) chips embedded in the transceivers of personnel, vehicles and equipment, and
one or more nodes or beacons in the air borne transceivers dispersed over an area on the ground;
the one or more nodes or beacons adapted to detect the RFID chips to facilitate locating the relative positions of the personnel, vehicles and equipment to each other by triangulation of the RFID chips.

The system preferably includes a global positioning (GPS) system.

The visual display is preferably a real-time representation showing the relative locations and movement of personnel, vehicles and equipment.

As the system is of a battlefield or terrestrial application, each transceiver preferably has its own power supply.

In a preferred embodiment, the system is initiated and managed via a smart device application or wireless app implementation on a smart tablet, smart phone or any other specially adapted smart device, and wherein the visual display is displayed on screens of the devices.

In another preferred example, the system can be incorporated into a helmet with smart communication abilities to be worn by soldiers in the battlefield. In this example, the visual display can be displayed on a heads up display visor of the smart helmet to show the relative locations and movement of other personnel, vehicles and equipment.

### BRIEF DESCRIPTION OF THE DRAWINGS

In order that the present invention is understood reference is made to the accompanying drawings wherein:

FIG. 1 is a drawing of a preferred air borne transceiver of the invention.

FIG. 2 is a drawing of the deployment of the invention.

FIG. 3 is a visual rendering of the real-time representation showing relative locations and movement of personnel, vehicles and equipment.

### DETAILED DESCRIPTION OF THE EMBODIMENTS

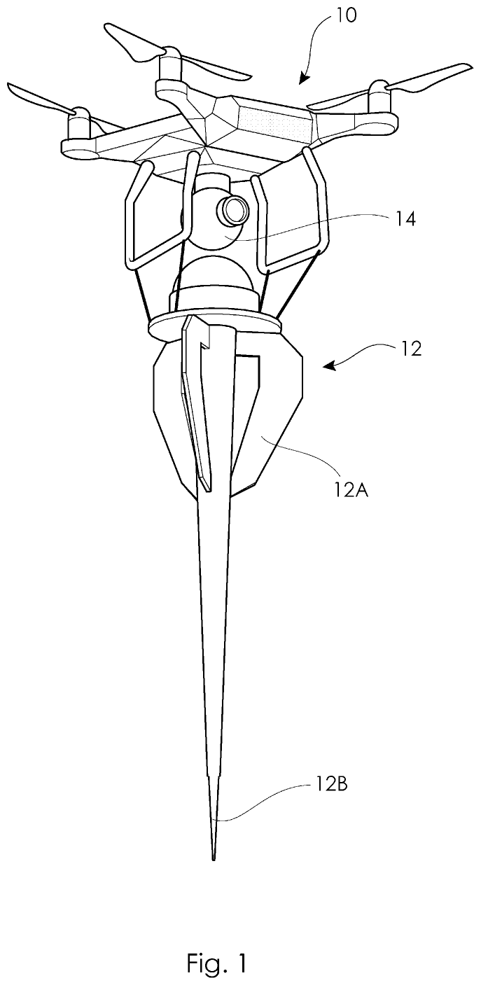

FIG. 1 shows a preferred remote control drone 10 and airborne transceiver 12 according to the invention. The transceiver is carried by the remotely controlled flying drone 10 which can also carry a camera 14. The transceiver 12 is released from the drone in a flight plan or path wherein a plurality of air borne transceivers is dispersed over a designated area on the ground.

Personnel transceivers (not shown) are carried or worn by persons on the ground. Equipment or vehicular transceivers are attached or installed on ground based equipment or vehicles (not shown).

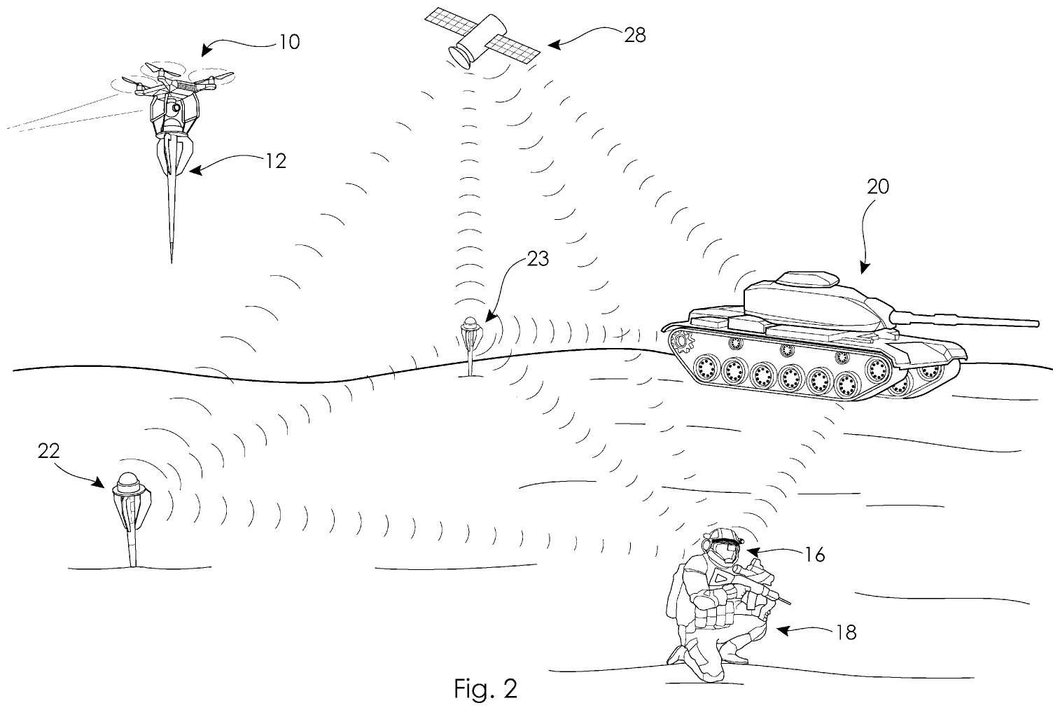

A central command computer which may be comprised of a platoon commander's helmet (see FIG. 2) is adapted to receive and process wireless geographical location information from the grounded airborne, equipment and vehicular transceivers.

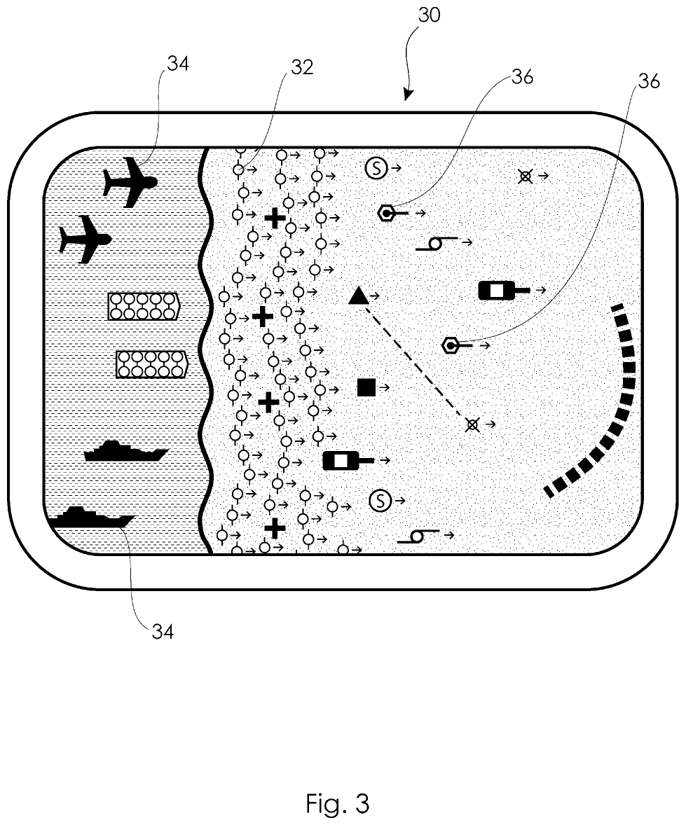

The central computer processes the location information to provide a seamless real time display of the relative positions of the personnel; vehicles and equipment to each other, wherein, changes to their location can be visually tracked and monitored in real time (refer FIG. 3).

Preferably, the air borne transceivers 12 are of a shape or configuration to enable them to travel through the air quietly and as noiselessly as possible. The air borne transceivers can have aerodynamic aids such as fins or vanes 12A to minimize sideways displacement as they fall to the ground on being released from the drones 10. They can have a ground piercing tip 12B or specially adapted base (not shown) to hold them in a substantially upright position on landing on the ground.

FIG. 2 shows the deployment of the system according to the invention. The central computer which in this example is comprised by the platoon commander's helmet 16 is in wireless communication with all of the transceivers via one or more wireless protocols.

In this example, the wireless protocol is a Bluetooth wireless communication protocol. In the alternative, or in addition, the wireless protocol includes a wireless personal area network. The wireless protocol can comprise a mesh network of radio frequency identification (RFID) chips embedded in the transceivers of personnel 18, vehicles 20 and other equipment, and

one or more nodes or beacons in the grounded air borne transceivers 22, 23 dispersed over an area on the ground. The one or more nodes or beacons are adapted to detect the RFID chips to facilitate locating the relative positions of the personnel, vehicles and equipment to each other by triangulation of the RFID chips. The system uses a satellite 28 based global positioning (GPS) system.

FIG. 3 is an example of a visual display 30, preferably in real-time showing the relative locations and movement of personnel 32, vehicles 34 and equipment 36 using symbolic representations. The visual display can be displayed on computer screens installed on equipment or in armored vehicles. Importantly, information can also be displayed on heads up display visors of smart helmets worn by the soldiers and on any smart devices such as mobile phones and tablets carried by troops.

As the system is of a battlefield or terrestrial application, each transceiver preferably has its own power supply.

In a preferred embodiment, and as previously mentioned, the system can be initiated and managed via a smart device application or wireless app implementation on a smart tablet, smart phone or any other specially adapted smart device carried by personnel or incorporated as part of a soldier's helmet with smart communication abilities.

It will of course be realized that while the foregoing has been given by way of illustrative example of this invention, all such and other modifications and variations thereto as would be apparent to persons skilled in the art are deemed to fall within the broad scope and ambit of this invention as herein set forth.

In the specification the terms “comprising” and “containing” shall be understood to have a broad meaning similar to the term “including” and will be understood to imply the inclusion of a stated integer or step or group of integers or steps but not the exclusion of any other integer or step or group of integers or steps. This definition also applies to variations on the terms “comprising” and “containing” such as “comprise”, “comprises”, “contain” and “contains”.

The invention claimed is:

1. A rapidly deployable drone seeded terrestrial real time visual detection and tracking system comprising:
one or more remotely controlled flying drones;
a plurality of airborne transceivers adapted to be released in the air by the one or more drones; the transceivers dispersed over an area on the ground;
personnel transceivers carried or worn by persons on the ground;
equipment or vehicular transceivers attached or installed on ground based equipment or vehicles;
a central command computer adapted to receive and process wireless location information from the drone dispersed, equipment and vehicular transceivers;
the computer processing the location information to provide a seamless real time visual display of the locations of the personnel, vehicles and equipment relative to each other, and wherein,
changes to their location can be visually tracked and monitored in real time.

2. The system of claim 1 wherein the air borne transceivers are of a shape or configuration to enable them to travel through the air as noiselessly as is possible.

3. The system of claim 1 wherein the air borne transceivers have aerodynamic aids such as fins or vanes to minimize sideways displacement as they fall to the ground on being released.

4. The system of claim 1 wherein the air borne transceivers have a ground piercing tip or specially adapted base to hold them in a substantially upright position on landing on the ground.

5. The system of claim 1 wherein the central computer is in wireless communication with each of the transceivers via one or more wireless protocols.

6. The system of claim 5 wherein the one or more wireless protocols is a Bluetooth wireless communication protocol.

7. The system of claim 5 wherein the one or more wireless protocols includes a wireless personal area network.

8. The system of claim 5 wherein the one or more wireless protocols includes:
a mesh network of radio frequency identification (RFID) chips embedded in the transceivers of personnel, vehicles and equipment, and
one or more nodes or beacons in the air borne transceivers dispersed over an area on the ground;
the one or more nodes or beacons adapted to detect the RFID chips to facilitate locating the relative positions of the personnel, vehicles and equipment to each other by triangulation of the RFID chips.

9. The system of claim 5 wherein the one or more wireless protocols includes a global positioning (GPS) system.

10. The system of claim 1 wherein the visual display is a real-time representation showing the relative location and movement of personnel, vehicles and equipment.

11. The system of claim 1 wherein the visual display is displayed on computer screens installed on equipment or in armored vehicles.

12. The system of claim 1 wherein the visual display is displayed on heads up display visors of smart helmets worn by soldiers.

13. The system of claim 1 wherein each transceiver has its own power supply.

14. The system of claim 1 initiated and managed via a smart device application or wireless app implementation on a smart tablet, smart phone or any other specially adapted smart device, and wherein the visual display is displayed on screens of these devices.

15. The system of claim 14 wherein the system is incorporated into a helmet with smart communication abilities to be worn by soldiers.
